(19) United States
(12) Patent Application Publication
(10) Pub. No.: US 2013/0322014 A1
(43) Pub. Date: Dec. 5, 2013

(54) ELECTRONIC DEVICE WITH RECEIVING APPARATUS FOR PORTABLE DEVICE

(71) Applicants: LEI LIU, Shenzhen City (CN); WEI-DONG CONG, Shenzhen City (CN)

(72) Inventors: LEI LIU, Shenzhen City (CN); WEI-DONG CONG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/525,376

(22) Filed: Jun. 18, 2012

(30) Foreign Application Priority Data
May 29, 2012 (CN) 201210170694.4

(51) Int. Cl. G06F 1/16

(52) U.S. Cl. 361/679.55

(57) ABSTRACT

An electronic device includes a chassis, a motherboard received in the chassis, a receiving portion installed in the chassis, a casing received in the receiving portion, and a printed circuit board (PCB) installed in the casing. Two openings are defined in two opposite ends of the receiving portion. One of the openings extends through an end wall of the chassis, and the other opening aligns with a connector mounted to the motherboard. The PCB includes a first connector connected to the connector of the motherboard, and a second connector connected to a connector of a portable device received in the casing.

### BACKGROUND

1. Technical Field

The present disclosure relates to electronic devices, and particularly, to an electronic device readily receiving a portable device.

2. Description of Related Art

Portable devices, such as mobile phone, moving picture experts group audio layer III (MP3) player, or mobile external hard disk drive, are generally connected to portable computers through a universal serial bus. The portable device is usually supported on a table. When the portable device is connected to the portable computer outdoors, using the universal serial bus is troublesome and inconvenient.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an exemplary embodiment of an electronic device together with a portable device.

FIG. 2 is a partially assembled, isometric view of FIG. 1.

FIG. 3 is an assembled, isometric view of the electronic device of FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean at least one.

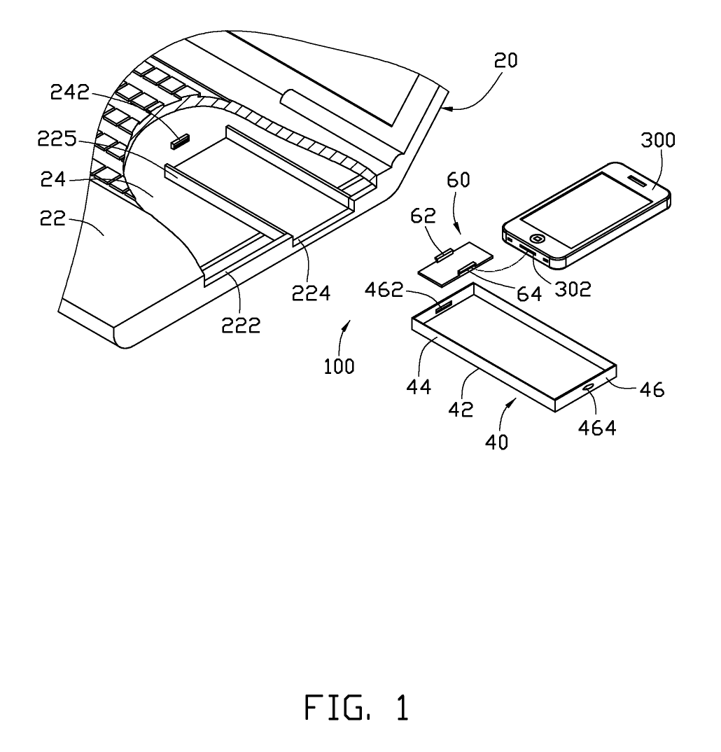

Referring to FIG. 1, an exemplary embodiment of an electronic device 100 for receiving a portable device 300 includes a main body 20, a casing 40, and a printed circuit board (PCB) 60. The portable device 300 includes a connector 302 formed on an end of the mobile phone 300. In the embodiment, the portable device 300 is a mobile phone, and the main body 20 is a portable computer.

The main body 20 includes a chassis 22 and a motherboard 24 received in the chassis 22. A substantially U-shaped receiving portion 225 is installed in the chassis 225. Two opposite ends of the receiving portion 225 define two openings 224. One opening 224 extends through an end wall 222 of the chassis 22, and the other opening 224 aligns with a connector 242 connected to the motherboard 24.

The casing 40 is a rectangular shell, and includes a bottom plate 42, two side plates 44 extending up from opposite sides of the bottom plate 42, and two end plates 46 extending up from opposite ends of the bottom plate 42. One end plate 46 defines a through hole 462 in a middle, and the other end plate 46 is recessed in to form an operation portion 464 in a middle.

The PCB 60 is rectangular, and includes a first connector 62 mounted to a first side of the PCB 60, and a second connector 64 mounted to a second side of the PCB 60 opposite to the first connector 62.

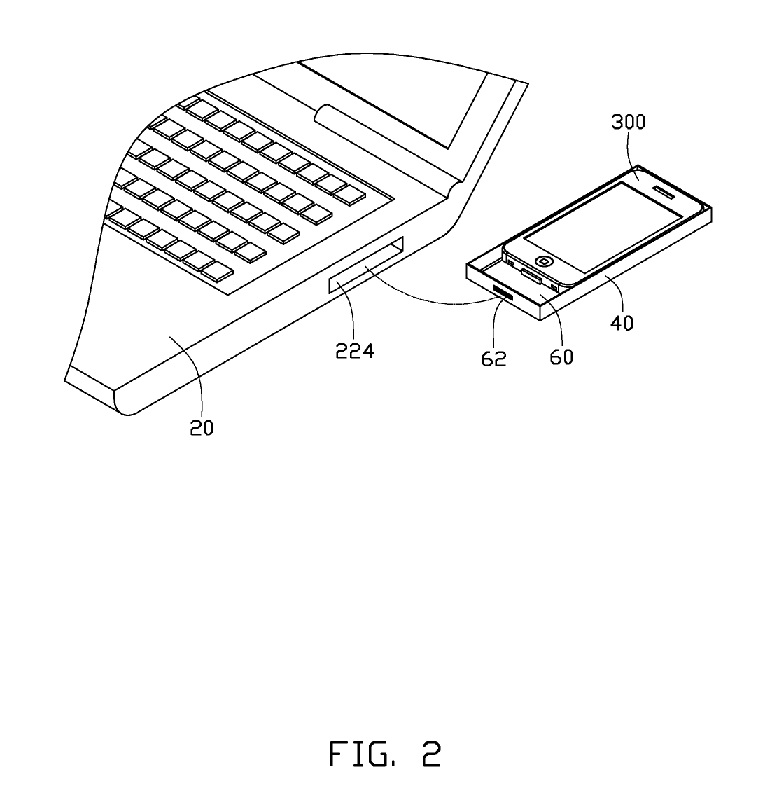

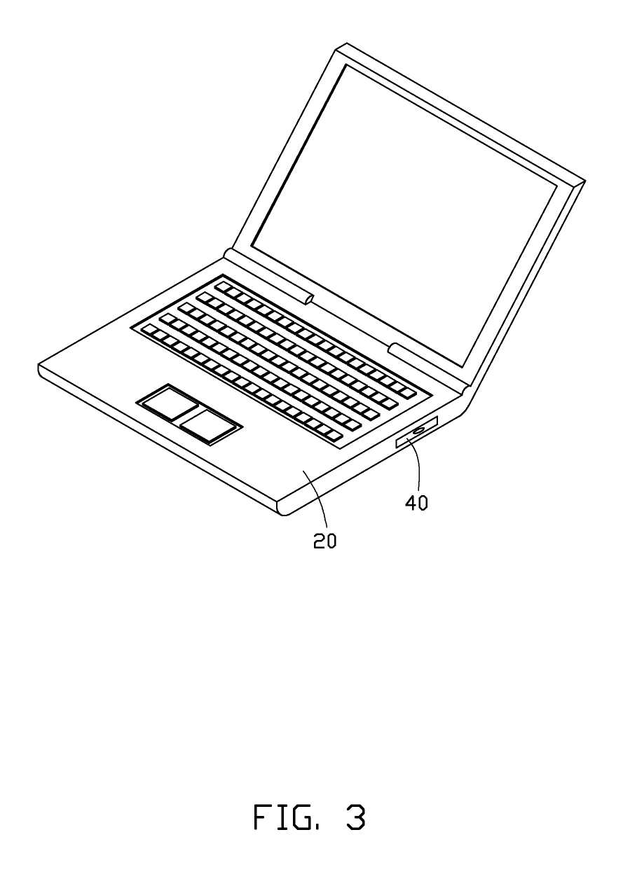

Referring to FIGS. 2 and 3, in assembly, the PCB 60 is installed in the casing 40 by a plurality of fasteners, such as screws, to allow the first connector 62 of the PCB 60 to extend through the through hole 462 of the end plate 46.

In use, the portable device 300 is received in the casing 40. The connector 302 of the portable device 300 is connected to the second connector 64 of the PCB 60. Thus, the PCB 60 is sandwiched between the end plate 46 defining the through hole 462 and the portable device 300. The end plate 46 with the through hole 462 is inserted into the receiving portion 225 from the opening 224 of the end wall 222, until the first connector 62 of the PCB 62 is connected to the connector 242 of the motherboard 24. The casing 40 with the portable device 300 is received in the main body 20, and the portable device 300 is electronically connected to the motherboard 24.

To detach the portable device 300 from the portable computer 20, the casing 40 is pulled away from the receiving portion 225 by manipulating the operation portion 464. The first connector 62 of the PCB 60 is disengaged from the connector 242 of the motherboard 24, until a part of the casing 40 is exposed out of the chassis 22. The portable device 300 can be moved away from the PCB 60, and the connector 302 of the portable device 300 is disengaged from the second connector 64 of the PCB 60. Therefore, the portable device 300 can be easily detached from the casing 40.

While the disclosure describes examples and embodiments, it is to be understood that the disclosure is not limited thereto. To the contrary, the disclosure is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A receiving apparatus for a portable device with a first connector, comprising:
a receiving portion installed in a chassis of an electronic device with a motherboard, the receiving portion defining a first and a second openings in two opposite ends of the receiving portion, the first opening extending through the chassis, and aligning with a second connector connected to the motherboard;
a casing for receiving the portable device, the casing detachably received in the receiving portion through the first opening; and
a printed circuit board (PCB) received in the casing, and comprising a third connector connected to the second connector of the motherboard, and a fourth connector detachably connected to the first connector of the portable device when the portable device is received in the casing.

2. The receiving apparatus of claim 1, wherein the casing comprises a bottom plate, two side plates extending up from opposite sides of the bottom plate, and two opposite end plates extending up from opposite ends of the bottom plate, one of the end plates defines a through hole for the third connecter of the PCB extending through to be connected to the second connector.

3. The receiving apparatus of claim 2 wherein the receiving portion is substantially U-shaped, the end plate with the through hole of the casing is inserted into the receiving portion through the first opening.

4. The receiving apparatus of claim 1, wherein the other end plate is recessed to form an operation portion in a middle.

5. An electronic device for receiving a portable device with a first connector, comprising:
a main body comprising a chassis, a motherboard received in the chassis, and a receiving portion installed in the chassis, the motherboard comprises a second connector, the receiving portion defining first and second openings in two opposite ends of the receiving portion, the first opening extending through the chassis, and the second opening aligning with the second connector;
a casing for receiving the portable device, the casing detachably received in the receiving portion through the first opening; and
a printed circuit board (PCB) received in the casing, and comprising a third connector connected to the second connector of the motherboard, and a fourth connector detachably connected to the first connector of the portable device when the portable device is received in the casing.

6. The electronic device of claim 5, wherein the casing comprises two opposite end plates, one of the end plates defines a through hole through which the third connecter of the PCB extends through to be connected to the second connector the motherboard.

7. The electronic device of claim 6, wherein the receiving portion is substantially U-shaped, the end plate with the through hole of the casing is inserted into the receiving portion through the first opening.

8. The electronic device of claim 6, wherein the other end plate of the casing is recessed to form an operation portion in a middle.
